(19) United States
(12) Patent Application Publication
(10) Pub. No.: US 2019/0162629 A1
(43) Pub. Date: May 30, 2019

(54) HUMIDITY MEASURING DEVICE

(71) Applicant: DENSO CORPORATION, Kariya-city (JP)

(72) Inventor: Teruaki KAIFU, Kariya-city (JP)

(21) Appl. No.: 16/265,207

(22) Filed: Feb. 1, 2019

Related U.S. Application Data
(63) Continuation of application No. PCT/JP2017/033617, filed on Sep. 18, 2017.

(30) Foreign Application Priority Data
Oct. 31, 2016 (JP) 2016-212622

(51) Int. Cl. G01M 15/04; F02M 35/10

(52) U.S. Cl. CPC G01M 15/042; F02M 35/10393

(57) ABSTRACT

A humidity measuring device is located at a vehicle and includes a humidity sensing unit configured to detect a humidity of an air, a humidity information acquisition unit configured to acquire a variation quantity of the humidity with time or a humidity information that is information relating to the variation quantity of the humidity with time, a vehicle information acquisition unit configured to acquire a vehicle information including at least one of information indicating a driving state of the vehicle or information of an attachment environment of the humidity sensing unit, a threshold setting unit configured to set a threshold for determining whether water is adhered to the humidity sensing unit, based on the vehicle information, and an adhesion determination unit configured to compare the humidity information with the threshold and to determine that water is adhered to the humidity sensing unit when the humidity information reaches the threshold.

### CROSS REFERENCE TO RELATED APPLICATIONS

The present application is a continuation application of International Patent Application No. PCT/JP2017/033617 filed on Sep. 18, 2017, which designated the U.S. and claims the benefit of priority from Japanese Patent Application No. 2016-212622 filed on Oct. 31, 2016. The entire disclosures of all of the above applications are incorporated herein by reference.

### TECHNICAL FIELD

The present disclosure relates to a humidity measuring device mounted to a vehicle.

### BACKGROUND

Conventionally, a humidity measuring device measures a humidity of an intake air of an internal combustion engine and includes a water adhesion determination unit that determines whether water is adhered to a surface of a sensor element of a humidity sensor detecting the humidity based on changes of the humidity and a temperature of the intake air.

### SUMMARY

According to an aspect of the present disclosure, the humidity measuring device is located at a vehicle and includes a humidity sensing unit configured to detect a humidity of an air, a humidity information acquisition unit configured to acquire a variation quantity of the humidity with time or a humidity information that is information relating to the variation quantity of the humidity with time, a vehicle information acquisition unit configured to acquire a vehicle information including at least one of information indicating a driving state of the vehicle or information of an attachment environment of the humidity sensing unit, a threshold setting unit configured to set a threshold for determining whether water is adhered to the humidity sensing unit, based on the vehicle information, and an adhesion determination unit configured to compare the humidity information with the threshold and to determine that water is adhered to the humidity sensing unit when the humidity information reaches the threshold.

### BRIEF DESCRIPTION OF DRAWINGS

The above and other objects, features and advantages of the present disclosure will become more apparent from the following detailed description made with reference to the accompanying drawings. In the drawings:

FIG. 1 is a perspective view showing a schematic configuration of an air flowmeter according to a first embodiment;

FIG. 2 is a cross-sectional view showing an attachment state of the air flowmeter according to the first embodiment;

FIG. 3 is a perspective view showing a schematic configuration of a humidity sensor device according to the first embodiment;

FIG. 4 is a cross-sectional view showing a schematic configuration of a humidity sensor chip according to the first embodiment;

FIG. 5 is a block diagram showing a schematic configuration of a system including the air flowmeter according to the first embodiment;

FIG. 6 is a flowchart showing a processing operation of a humidity processing unit according to the first embodiment;

FIG. 7 is a graph showing a time change of a humidity variation quantity according to the first embodiment;

FIG. 8 is a graph showing a time change of a relative humidity;

FIG. 9 is a graph showing a time change of the relative humidity in a high-speed traveling and a low-speed traveling;

FIG. 10 is a graph showing a relationship between the humidity variation quantity and a threshold, according to the first embodiment;

FIG. 11 is a flowchart showing a processing operation of the humidity processing unit according to a second embodiment;

FIG. 12 is a table showing a relationship between each vehicle information and the threshold, according to the second embodiment; and

FIG. 13 is a table showing a relationship between each vehicle information and the threshold, according to the second embodiment.

### DETAILED DESCRIPTION

The following describes a plurality of embodiments for carrying out the present disclosure with reference to the drawings. In each of the embodiments, portions corresponding to the elements described in the preceding embodiments are denoted by the same reference numerals, and redundant explanation may be omitted. In each of the embodiments, when only a part of the configuration is described, the other parts of the configuration can be applied with reference to the other embodiments described above. Similarly, step numerals can be applied with reference to the other embodiments described above.

### First Embodiment

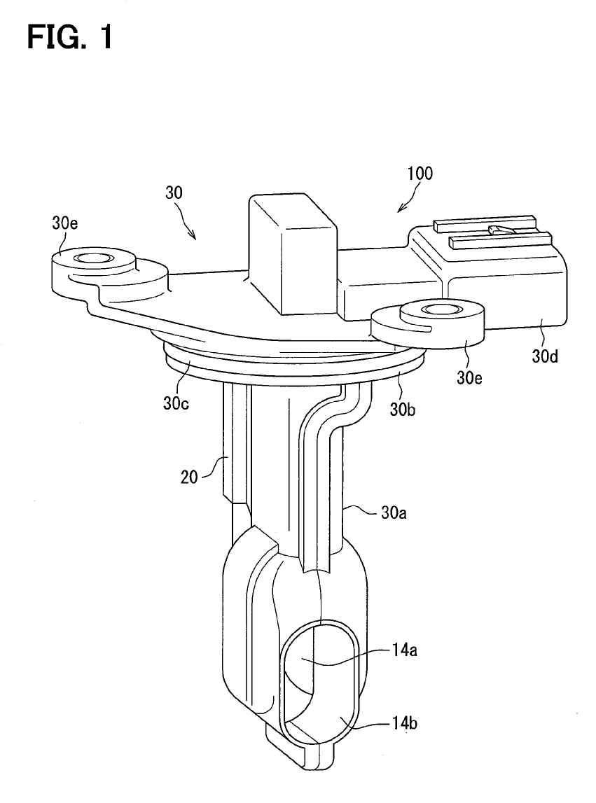

According to the present embodiment, as an example, the present disclosure is applied to a humidity sensor device 20. Further, as shown in FIG. 1 or the like, the humidity sensor device 20 is attached to an air flowmeter 100. Thus, the air flowmeter 100 is an air flowmeter having a humidity measurement function.

The air flowmeter 100 is mounted to a vehicle including an engine that is an internal combustion engine. The air flowmeter 100 is applied to an intake system of the engine. The air flowmeter 100 is a thermal type and has an air flow-rate measurement function to measure a flow rate of an intake air that is an air suctioned to a cylinder of the engine. The air flowmeter 100 outputs sensor output signals corresponding to the flow rate of the intake air and a humidity of the intake air which flows in a duct 1, to an engine control device 200 that is an external device. The external device is a device provided separately from the air flowmeter 100 and is a device electrically connected with the air flowmeter 100. Hereafter, the flow rate of the intake air is referred to as an intake flow rate, the humidity of the intake air is referred to as an intake humidity, and then engine control device is referred to as a control device.

First, referring to FIGS. 1 to 5, configurations of the humidity sensor device 20 and the air flowmeter 100 to which the humidity sensor device 20 is attached will be described.

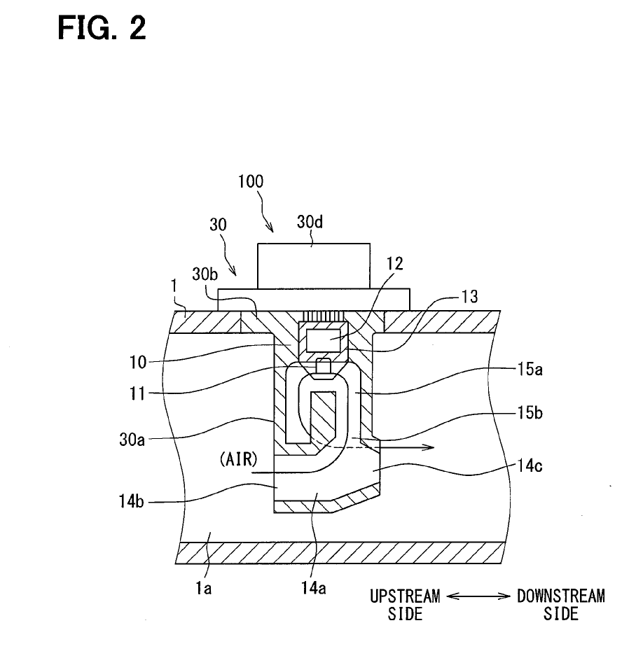

The air flowmeter 100 includes a flow rate sensor device 10, the humidity sensor device 20, and a housing 30. As shown in FIGS. 1 and 2, in the air flowmeter 100, the flow rate sensor device 10 and the humidity sensor device 20 are located at the housing 30.

As shown in FIG. 2, the air flowmeter 100 is detachable attached to the duct 1 such as an intake pipe (intake duct), an outlet duct of an air cleaner, or the like. The air flowmeter 100 is inserted into a sensor insertion hole that penetrates a wall surface of the duct 1, and a part of the air flowmeter 100 is located in a main passage 1a of the duct 1. In other words, in a state where the air flowmeter 100 is attached to the duct 1, a part of the flow rate sensor device 10 and a part of the humidity sensor device 20 are located at an environment where the intake air flows. A part of the flow rate sensor device 10 includes a flow rate sensing unit 11 which will be described later. On the other hand, a part of the humidity sensor device 20 includes a humidity sensing unit 21b and a temperature sensing unit 21c which will be described later.

As shown in FIGS. 1 and 2, for example, the housing 30 includes a bypass portion 30a, an engagement portion 30b, an O-ring 30c, a connector portion 30d, and a fixing portion 30e.

The bypass portion 30a defines a bypass passage 14a and a sub bypass passage 15a through which a part of the intake air flowing through the main passage 1a passes. The bypass passage 14a is a passage between a bypass passage inlet 14b and a bypass passage outlet 14c. The sub bypass passage 15a is a passage to which a part of the intake air, flowing through the bypass passage 14a, flows from a sub bypass passage inlet 15b.

The engagement portion 30b is a portion engaged to the sensor insertion hole of the duct 1 through the O-ring 30c. The connector portion 30d is a portion surrounding a terminal for electrical connection between the flow rate sensor device 10 and the external device such as the control device 200 and connection between the humidity sensor device 20 and the external device such as the control device 200. In other words, the terminal is configured to be electrically connected with the flow rate sensor device 10, the humidity sensor device 20 and the control device 200. The fixing portion 30e is a portion for fixing the air flowmeter 100 to the duct 1.

The housing 30 will be briefly described. The housing 30, for example, may be a housing disclosed in JP2016-109625A. The air flowmeter 100, for example, is configured to be electrically connected with the control device 200 through the terminal. However, the air flowmeter 100 may have a configuration that can communicate with the control device 200 by the sensor signal or the like. Thus, the air flowmeter 100 may wirelessly communicate with the control device 200.

The flow rate sensor device 10 outputs a sensor signal corresponding to the intake flow rate of the intake air flowing through the sub bypass passage 15a. The sensor signal corresponding to the intake flow rate can also be referred to as a flow rate signal. The flow rate signal is also a sensor signal indicating the intake flow rate of the intake air flowing through the sub bypass passage 15a. As shown in FIG. 2, the flow rate sensor device 10 includes the flow rate sensing unit 11, a flow rate processing unit 12, and a flow rate sensor housing 13 that receives the flow rate sensing unit 11 and the flow rate processing unit 12.

In a state where the housing 30 is attached to the duct 1, the flow rate sensing unit 11 is located at the sub bypass passage 15a. The flow rate processing unit 12 is electrically connected with the flow rate sensing unit 11 and controls an input-output signal for the flow rate sensing unit 11. The flow rate processing unit 12 is electrically connected with the terminal of the connector portion 30d. Thus, the air flowmeter 100 can output the flow rate signal to the control device 200. In addition, the flow rate sensor device 10, for example, may be a flow rate sensor disclosed in JP2015-90338A.

The humidity sensor device 20 outputs a sensor signal corresponding to the intake humidity of the intake air flowing through the main passage 1a. Further, the humidity sensor device 20 outputs a sensor signal corresponding to a temperature (intake temperature) of the intake air flowing through the main passage 1a. The sensor signal corresponding to the intake humidity can be referred to as a humidity signal. The sensor signal corresponding to the temperature can be referred to as a temperature signal. In addition, the humidity signal is also a sensor signal indicating the intake humidity of the intake air flowing through the main passage 1a. The temperature signal is also a sensor signal indicating the intake temperature of the intake air flowing through the main passage 1a.

According to the present embodiment, the humidity sensor device 20 is a relative humidity sensor that detects a relative humidity. However, the present disclosure is not limited to the above, and the humidity sensor device 20 may be a weight absolute humidity sensor. In other words, according to the present disclosure, when the humidity sensor device 20 is the weight absolute humidity sensor, following effects can be obtained.

When water is adhered to the humidity sensing unit 21b to be described later by a condensation, the humidity sensor device 20 determines the condensation in response to a time change of the humidity signal exceeding a threshold Th. The threshold Th is set based on vehicle information including a vehicle speed, an engine rotation speed, the intake flow rate or the like.

As shown in FIG. 1, the humidity sensor device 20 is different from the flow rate sensor device 10 that the humidity sensor device 20 is located outside of the bypass portion 30a. In other words, the humidity sensor device 20 is located at the main passage 1a. However, the present disclosure is not limited to the above, and the humidity sensor device 20 may be located at the bypass passage 14a or the sub bypass passage 15a.

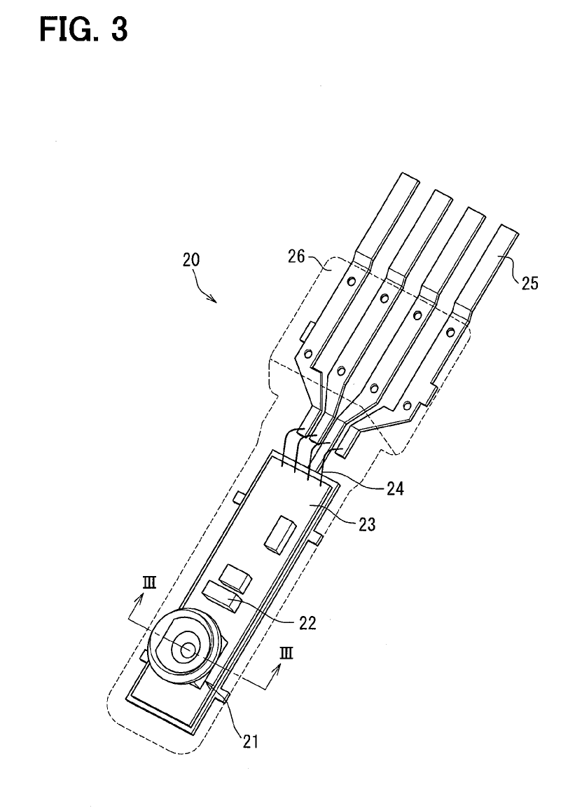

As shown in FIG. 3, the humidity sensor device 20 includes a humidity sensor chip 21, a humidity processing unit 22, a humidity sensor substrate 23, a wire 24, a terminal 25, and a sealing portion 26. Further, as shown in FIG. 3, to make an internal configuration of the sealing portion 21g easy to be understood, the sealing portion 21g is indicated by a dotted line, and elements sealed by the sealing portion 21g are indicated by solid lines.

The humidity sensor chip 21 and the humidity processing unit 22 are electrically connected with each other through the humidity sensor substrate 23. The humidity sensor substrate 23, for example, is defined by an insulation base part on which a conductive wiring is arranged. The humidity sensor chip 21 and the humidity processing unit 22 are electrically connected with each other through the conductive wiring. Thus, the humidity processing unit 22 can receive the humidity signal output from the humidity sensing unit 21b located at the humidity sensor chip 21 and the temperature signal output from the temperature sensing unit 21c located at the humidity sensor chip 21.

The humidity sensor substrate 23 is implemented to a part of a lead frame. The humidity sensor substrate 23 is electrically connected with the terminal 25, which is the other part of the lead frame, through the wire 24. The sealing portion 26 is in contact with elements 21, 22, 23, 24 and 25 and covers the elements 21, 22, 23, 24 and 25, in a state where a tip end of the terminal 25 is exposed. Thus, in the humidity sensor device 20, the elements 21, 22, 23, 24 and 25 are protected by the sealing portion 26.

A part of the terminal 25 which is exposed from the sealing portion 26 is electrically connected with the terminal of the connector portion 30d. Thus, the humidity processing unit 22 is electrically connected with the connector portion 30d through the humidity sensor substrate 23, the wire 24 and the terminal 25. Then, the air flowmeter 100 (humidity processing unit 22) can output the humidity signal and the temperature signal to the control device 200. Further, the humidity processing unit 22 is configured to receive various sensor signals from the control device 200.

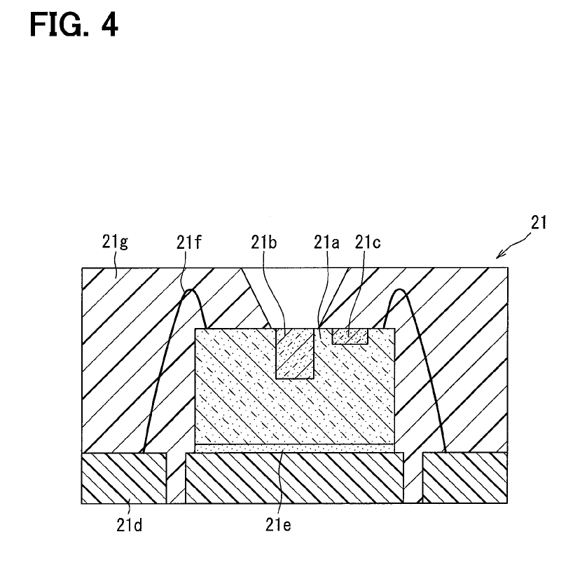

As shown in FIG. 4, the humidity sensor chip 21 includes a substrate 21a, an electrode 21d, a bonding part 21e, a wire 21f, and the sealing portion 21g. FIG. 4 is a cross-sectional view of the humidity sensor chip 21 taken along an III-III line in FIG. 3.

The substrate 21a includes the humidity sensing unit 21b and the temperature sensing unit 21c. The humidity sensing unit 21b is a portion to detect the intake humidity. The temperature sensing unit 21c is a portion to detect the intake temperature. As the above description, the humidity sensing unit 21b and the temperature sensing unit 21c are located at one substrate 21a. Thus, the temperature sensing unit 21c can detect a temperature at a position the same as a position where the humidity sensing unit 21b detects the humidity. In addition, the humidity sensing unit 21b and the temperature sensing unit 21c are located to be adjacent to each other or to be in the vicinity of each other. Thus, the temperature signal is a sensor signal indicating the temperature of the humidity sensor device 20, and is also a sensor temperature.

The humidity sensing unit 21b may be adhered by water due to a condensation, for example. When water is adhered to the humidity sensing unit 21b, the humidity sensing unit 21b cannot appropriately detect the intake humidity. In this case, the humidity processing unit 22 determines whether water is adhered to the humidity sensing unit 21b.

In addition, the substrate 21a is bonded to the bonding part 21e through a base seat. The base seat, for example, may be a die pad at the lead frame including the electrode 21d.

The substrate 21a includes electrodes electrically connected with the humidity sensing unit 21b and the temperature sensing unit 21c, and the electrodes are electrically connected with a part of the wire 21f. The other part of the wire 21f is electrically connected with the electrode 21d. Thus, in the substrate 21a, the humidity sensing unit 21b and the temperature sensing unit 21c are electrically connected with the electrode 21d through the wire 21f.

The sealing portion 21g is in contact with elements 21a, 21b, 21c, 21d, 21e and 21f and covers the elements 21a, 21b, 21c, 21d, 21e and 21f, in a state where a part of the humidity sensing unit 21b and the electrode 21d is exposed. Thus, in the humidity sensor chip 21, the elements 21a, 21b, 21c, 21d, 21e and 21f are protected by the sealing portion 21g. In the humidity sensor chip 21, a portion in the electrode 21d exposed from the sealing portion 21g, and the conductive wiring of the humidity sensor substrate 23, are electrically connected with each other through a conductive connection component such as a solder or the like.

According to the present embodiment, the humidity sensor device 20 includes the temperature sensing unit 21c. However, the present disclosure is not limited to the above, and the humidity sensor device 20 may not include the temperature sensing unit 21c.

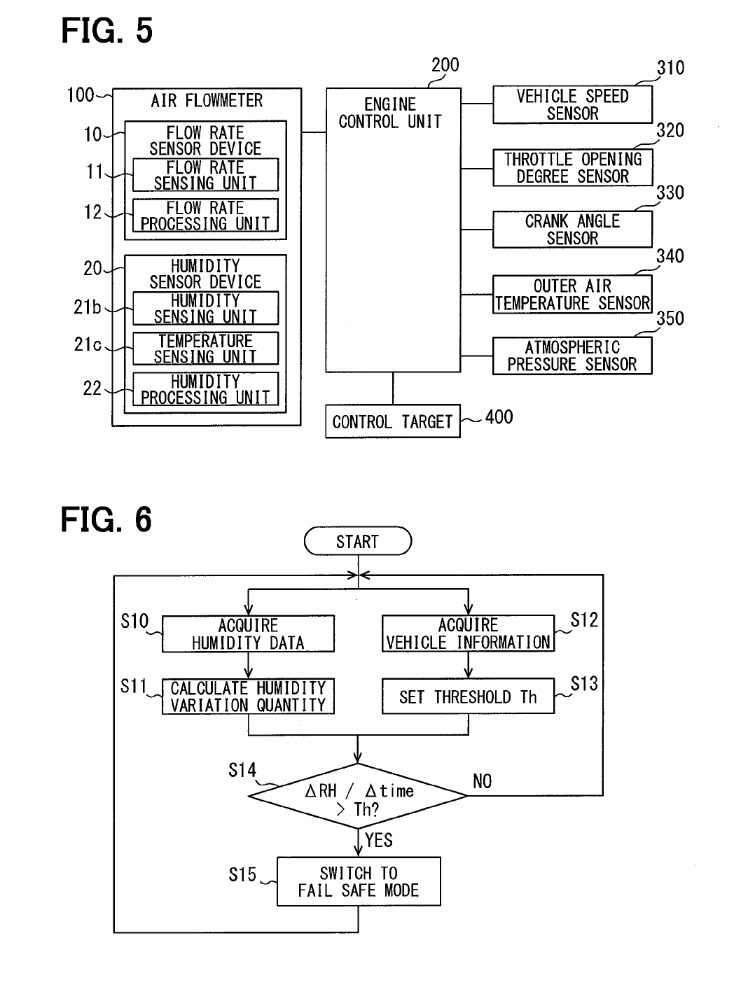

As shown in FIG. 5, the air flowmeter 100 is electrically connected with the control device 200. The control device 200 is electrically connected with the air flowmeter 100, a vehicle speed sensor 310, a throttle opening degree sensor 320, a crank angle sensor 330, an outer air temperature sensor 340, an atmospheric pressure sensor 350 and the like. Further, the control device 200 is electrically connected with the engine that is a control target 400 and executes an engine control.

The vehicle speed sensor 310 outputs a sensor signal indicating a vehicle speed that is a traveling speed of the vehicle. The throttle opening degree sensor 320 outputs a sensor signal indicating a throttle opening degree of the vehicle. The crank angle sensor 330 outputs a sensor signal indicating the engine rotation speed. The outer air temperature sensor 340 outputs a sensor signal indicating a temperature (outer air temperature) of an outer air of the vehicle. The atmospheric pressure sensor 350 outputs a sensor signal indicating a pressure of the outer air of the vehicle.

The sensor signal indicating the vehicle speed, the sensor signal indicating the throttle opening degree, the sensor signal indicating the engine rotation speed and the flow rate signal can be used as the vehicle information for setting the threshold Th. According to the present embodiment, as an example of the vehicle information for setting the threshold Th, the sensor signal indicating the vehicle speed is used.

Thus, the humidity processing unit 22 may acquire the sensor signal indicating the vehicle speed without acquiring the sensor signal indicating the throttle opening degree, the sensor signal indicating the engine rotation speed and the flow rate signal. In other words, the humidity processing unit 22 may acquire a sensor signal, which is necessary for setting the threshold Th, among the sensor signal indicating the vehicle speed, the sensor signal indicating the throttle opening degree, the sensor signal indicating the engine rotation speed and the flow rate signal.

As the vehicle information for setting the threshold Th, a time change of the vehicle speed, a time change of the throttle opening degree, a time change of the engine rotation speed or a time change of the intake flow rate can be used. In this case, the humidity processing unit 22 can acquire the above time changes. For example, when the time change of the vehicle speed is used, the humidity processing unit 22 can acquire the time change of the vehicle speed. The humidity processing unit 22 may acquire the time changes by itself based on the sensor signals output from the sensors, and may acquire the time changes from the control device 200 or the like. Further, similar to the above sensor signals, the humidity processing unit 22 may acquire a time change which is necessary for setting the threshold Th.

The time changes are information relating to respective sensor signals. For example, the time change of the vehicle speed is information relating to the vehicle speed.

The control device 200 includes a microcomputer including a CPU, a memory that includes a ROM and a RAM, an input unit, an output unit, a power circuit and the like. The control device 200 can acquire the flow rate signal and the humidity signal output from the air flowmeter 100 and can acquire the sensor signals output from sensors 310, 320, 330, 340 and 350.

The control device 200 executes the engine control including an air-fuel ratio control, a fuel injection control and the like, by using the flow rate signal, the humidity signal and the sensor signals which are acquired. For example, the control device 200 calculates a fuel injection quantity of a fuel supplied and injected from an injection port of an injector to the engine 400, based on the flow rate signal or the humidity signal which is acquired. The control device 200 variably controls an energization time (a valve-opening interval) of the injector in response to the fuel injection quantity that is calculated.

Recently, an engine control highly fit to a surrounding environment (weather or the like) is required for a purpose of achieving a low fuel consumption. Thus, in the engine control, it is required to measure physical quantities other than the intake flow rate supplied to the cylinder of the engine 400 through the air cleaner, such as humidity or the like, with high response and high precision. To satisfy the above requirement, the air flowmeter 100 is provided with the humidity sensor device 20 in addition to the flow rate sensor device 10 and outputs the flow rate signal and the humidity signal to the control device 200.

Referring to FIGS. 6 to 10, a processing operation of the humidity sensor device 20 will be described. In the humidity sensor device 20, the humidity processing unit 22 executes a processing of a flowchart shown in FIG. 6, while an ignition switch of the vehicle is being turned on or the vehicle is traveling.

At S10, the humidity processing unit 22 acquires a humidity data. The humidity processing unit 22 acquires the humidity data from the humidity sensing unit 21b. In other words, the humidity processing unit 22 successively acquires the humidity signal output from the humidity sensing unit 21b to calculate a humidity variation quantity. S10 is equivalent to a humidity information acquisition unit.

At S11, the humidity processing unit 22 calculates the humidity variation quantity (ΔRH/Δtime). The humidity processing unit 22 calculates a variation quantity of the humidity signal acquired at S10 with time. S11 is equivalent to the humidity information acquisition unit.

At S12, the humidity processing unit 22 acquires the vehicle information. The humidity processing unit 22 acquires the sensor signal indicating the vehicle speed from the control device 200, as the vehicle information. In other words, the humidity processing unit 22 successively acquires the sensor signal indicating the vehicle speed output from the control device 200 to set the threshold Th. S12 is equivalent to a vehicle information acquisition unit.

At S13, the humidity processing unit 22 sets the threshold Th. The humidity processing unit 22 sets the threshold Th for comparing the humidity variation quantity (ΔRH/Δtime) and the threshold Th when determining whether water is adhered to the humidity sensing unit 21b. S13 is equivalent to a threshold setting unit.

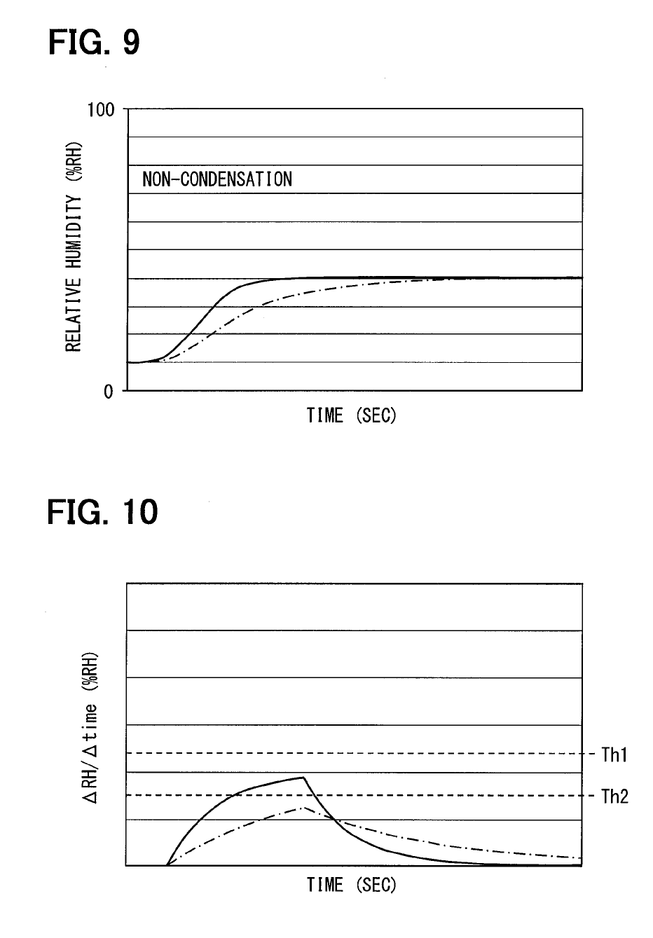

Since the vehicle speed becomes higher, a change of an environment of the vehicle becomes faster. Then, a change of an outer air humidity becomes faster. In other words, the relative humidity of when the vehicle is in a high speed traveling as a solid line shown in FIG. 9 is faster than the relative humidity of when the vehicle is in a low speed traveling as a dotted dashed line shown in FIG. 9 in change.

Thus, as shown in FIG. 10, the humidity processing unit 22 sets a threshold Th1 of when the vehicle speed is high to be greater than a threshold Th2 of when the vehicle speed is low. In other words, the humidity processing unit 22 sets the threshold Th to be a greater value in response to the vehicle speed becoming higher. In addition, the threshold Th can be referred to as a water adhesion determination threshold.

As the above description, since the humidity processing unit 22 increases the threshold of when the vehicle speed is high rather than the threshold of when the vehicle speed is low, an erroneous detection of the condensation caused by an actual humidity variation can be suppressed. That is, the humidity processing unit 22 can suppress an erroneous detection where it is determined that water is adhered to the humidity sensing unit 21b in response to the humidity that is high while water is not adhered to the humidity sensing unit 21b. The humidity processing unit 22 can set the threshold Th to an appropriate value.

Similarly, in a case where the humidity processing unit 22 uses the time change of the vehicle speed as the vehicle information for setting the threshold Th, the humidity processing unit 22 sets a threshold Th1 of when the time change is large to be greater than a threshold Th2 of when the time change is small.

At S14, the humidity processing unit 22 determines whether the humidity variation quantity (ΔRH/Δtime) exceeds the threshold Th. When the humidity processing unit 22 determines that the humidity variation quantity does not exceed the threshold, the humidity processing unit 22 determines that water is not adhered to the humidity sensing unit 21b and then returns to S10, S12. When the humidity processing unit 22 determines that the humidity variation quantity exceeds the threshold Th, the humidity processing unit 22 determines that water is adhered to the humidity sensing unit 21b and then proceeds to S15. The humidity variation quantity is equivalent to humidity information. S14 is equivalent to an adhesion determination unit.

It is preferable that the humidity processing unit 22 instantaneously determines that water is adhered to the humidity sensing unit 21b when the humidity variation quantity exceeds the threshold Th. In other words, it is preferable that the humidity processing unit 22 determines the adhesion at a timing where the humidity variation quantity exceeds the threshold Th, without determining the adhesion when a state where the humidity variation quantity exceeds the threshold Th is continued for a predetermined time and without determining that adhesion when a total number of times where the humidity variation quantity exceeds the threshold Th reaches a predetermined number of times. Thus, the humidity processing unit 22 can rapidly detect a state where water is adhered to the humidity sensing unit 21b.

At S15, the humidity processing unit 22 switches to a fail safe mode. When the humidity processing unit 22 switches to the fail safe mode, the humidity processing unit 22 outputs a fixed value that is previously set, instead of outputting the humidity signal detected by the humidity sensing unit 21b. The fixed value, for example, can be a value where a disturb is not generated in a traveling function and an exhaust gas while the control device 200 executes the engine control by using the humidity signal. Thus, the humidity sensor device 20 can suppress an erroneous operation of the vehicle. When the humidity processing unit 22 determines that water is not adhered to the humidity sensing unit 21b, the humidity processing unit 22 outputs the humidity signal detected at the humidity sensing unit 21b.

According to the present disclosure, the control device 200 may execute a processing of a flowchart shown in FIG. 6. In this case, the humidity measuring device includes a part of the control device 200 in addition to the humidity sensor device 20. That is, the humidity measuring device includes a part of the control device 200 which executes the processing of the humidity processing unit 22.

According to the present disclosure, a part that executes the processing of the flowchart shown in FIG. 6 may be provided separately from the humidity sensor device 20 in the air flowmeter 100. In this case, the humidity measuring device includes a part of the air flowmeter 100 in addition to the humidity sensor device 20. That is, the humidity measuring device includes a part of the air flowmeter 100 which executes the processing of the humidity processing unit 22.

Hereafter, effects of the humidity sensor device 20 will be described with reference to humidity measuring devices of comparison examples. When the humidity is close to 100%, the humidity measuring devices of the comparison examples determine that water is adhered to a humidity sensing unit.

According to a first comparison example, a water adhesion determination unit determines whether an absolute water content changes to be greater than a reference value set in response to a pressure of the intake air. When the absolute water content changes to be greater than the reference value, the water adhesion determination unit determines that water is adhered to a surface of a sensor element of a humidity sensor.

However, whether water is adhered to the surface of the sensor element of the humidity sensor cannot be correctly determined only by the pressure of the intake air. The above humidity measuring device cannot determine that water is adhered until outputting a signal indicating that the humidity is in the vicinity of 100%. Thus, a responsiveness of the above humidity measuring device is low.

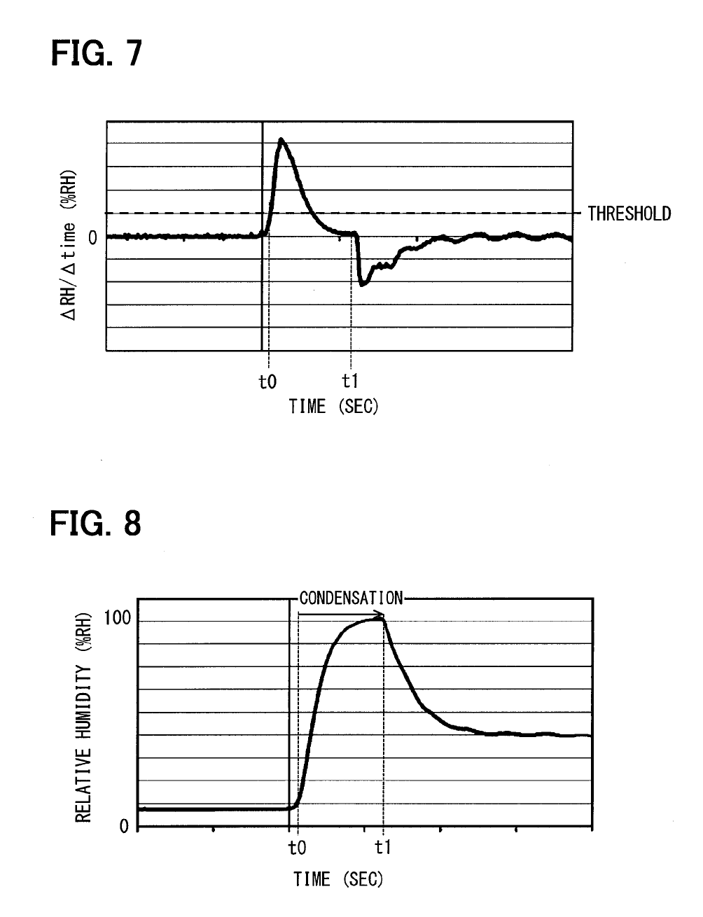

As shown in FIG. 8, the humidity measuring device of a second comparison example cannot determine that water is adhered until a timing t1 in a case where the condensation is generated at a timing t0. In other words, the above humidity measuring device has a low responsiveness. In contrast, as shown in FIG. 7, the humidity sensor device 20 can determine that water is adhered to the humidity sensing unit 21b at a timing t0.

Since the humidity sensor device 20 determines whether water is adhered to the humidity sensing unit 21b based on the humidity variation quantity, it can be rapidly determined that water is adhered to the humidity sensing unit 21b. In other words, the humidity sensor device 20 can detect that water is adhered to the humidity sensing unit 21b with a high response.

Since the humidity sensor device 20 determines whether water is adhered to the humidity sensing unit 21b based on the humidity variation quantity, a detection error caused by a response delay disappears and it can be detected that water is adhered to the humidity sensing unit 21b with a high sensitivity. In other words, the humidity sensor device 20 can early and correctly determine that water is adhered to the humidity sensing unit 21b.

Since the humidity sensor device 20 sets the threshold Th for determining whether water is adhered to the humidity sensing unit 21b in response to vehicle information (vehicle speed), the erroneous detection can be suppressed.

According to the present embodiment, the humidity variation quantity is used as a value to be compared with the threshold Th. However, the present disclosure is not limited to the above, and information equivalent to the humidity variation quantity, such as a change ratio of a humidity and a temperature or the like, can be used. In this case, the humidity processing unit 22 may execute a processing to acquire information relating to the humidity variation quantity instead of executing S10 and S11. According to the present disclosure, when information relating to the humidity variation quantity is used, the same effects as a case where the humidity variation quantity is used can be obtained. The information relating to the humidity variation quantity is equivalent to humidity information.

Hereafter, a case where a sensor signal other than the vehicle speed is used as the vehicle information for setting the threshold Th will be described.

A case where the engine rotation speed is used to set the threshold Th will be described. When the throttle opening degree is the same, an intake air quantity increases in accordance with an increase in engine rotation speed in the vehicle. In the duct 1, when the intake air quantity increases, a humidity change also increases in response to a change of a humidity environment in an outer air. Thus, the humidity processing unit 22 sets a threshold Th1 of when the engine rotation speed is high to be greater than a threshold Th2 of when the engine rotation speed is low. Then, the humidity processing unit 22 can suppress the erroneous detection of the condensation caused by the actual humidity variation. Similarly, when the time change of the engine rotation speed is used as the vehicle information, the humidity processing unit 22 sets a threshold Th1 of when the time change is large to be greater than a threshold Th2 of when the time change is small.

A case where the intake flow rate is used to set the threshold Th will be described. In the duct 1, when the intake air quantity increases, the humidity change also increases in response to the change of the humidity environment in the outer air. Thus, the humidity processing unit 22 sets a threshold Th1 of when the intake flow rate is large to be greater than a threshold Th2 of when the intake flow rate is small. Then, the humidity processing unit 22 can suppress the erroneous detection of the condensation caused by the actual humidity variation. Similarly, when the time change of the intake flow rate is used as the vehicle information, the humidity processing unit 22 sets a threshold Th1 of when the time change is large to be greater than a threshold Th2 of when the time change is small.

A case where the throttle opening degree is used to set the threshold Th will be described. In the vehicle, the intake air quantity increases in accordance with an increase in throttle opening degree. In the duct 1, when the intake air quantity increases, the humidity change also increases in response to the change of the humidity environment in the outer air. Thus, the humidity processing unit 22 sets a threshold Th1 of when the throttle opening degree is large to be greater than a threshold Th2 of when the throttle opening degree is small. Then, the humidity processing unit 22 can suppress the erroneous detection of the condensation caused by the actual humidity variation. Similarly, when the time change of the throttle opening degree is used as the vehicle information, the humidity processing unit 22 sets a threshold Th1 of when the time change is large to be greater than a threshold Th2 of when the time change is small.

As the above description, the vehicle information for setting the threshold Th can be referred to as information indicating a traveling state of the vehicle, information indicating a driving state of the vehicle or the like.

In this disclosure, the humidity measuring device sets the threshold based on the vehicle information that is acquired. When the humidity information reaches the threshold, the humidity measuring device determines that water is adhered to the humidity sensing unit. Thus, in this disclosure, the humidity measuring device can determine that water is adhered to the humidity sensing unit before the humidity becomes in the vicinity of 100%. Then, in this disclosure, the humidity measuring device can detect that water is adhered to the humidity sensing unit with a high response. Further, in this disclosure, since the threshold for determining whether water is adhered to the humidity sensing unit is set in response to the vehicle information, an erroneous detection can be suppressed.

It is an object of this disclosure to provide a humidity measuring device which can suppress an erroneous detection and can detect a water adhesion with a high response.

As the above, a preferred embodiment of the present disclosure is described. However, the present disclosure is not limited to the embodiment described above, and various modifications are possible within the scope of the present disclosure without departing from the spirit of the present disclosure.

### Second Embodiment

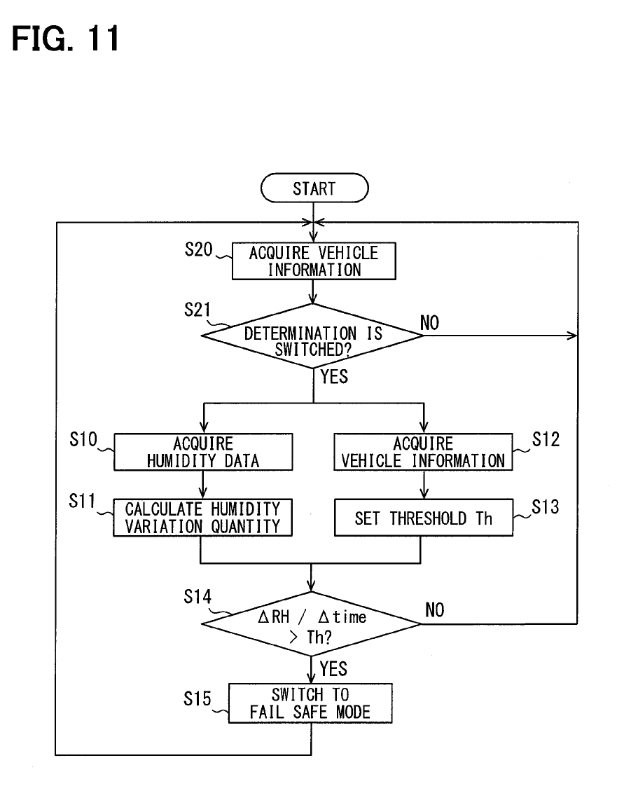

Referring to FIGS. 11 to 13, a processing operation of the humidity sensor device 20 according to the present embodiment will be described.

According to the above embodiment, information indicating traveling information of the vehicle is used as the vehicle information for setting the threshold Th. However, according to the present disclosure, information relating to a sensor temperature can be used as the vehicle information for setting the threshold Th.

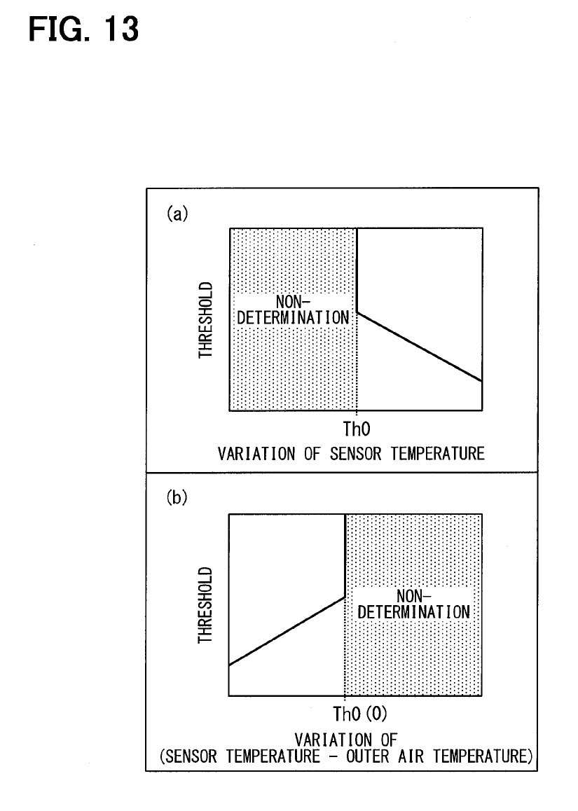

As shown in (a) of FIG. 13, a time change of the sensor temperature can be used as the information relating to the sensor temperature for setting the threshold Th. In this case, the humidity processing unit 22 can acquire the time change of the sensor temperature. The humidity processing unit 22 may acquire the time change of the sensor temperature by itself from the sensor signal indicating the sensor temperature, and may acquire the time change of the sensor temperature from the control device 200.

When a sensor temperature change becomes larger at a positive side, the humidity sensing unit 21b becomes more readily condensed. The humidity processing unit 22 sets a threshold Th1 of when the time change of the sensor temperature is smaller than the positive side to be greater than a threshold Th2 of when the time change of the sensor temperature is larger than the positive side. Thus, the humidity processing unit 22 can improve a determination sensitivity of the condensation, that is, the humidity processing unit 22 can improve a determination sensitivity of a water adhesion.

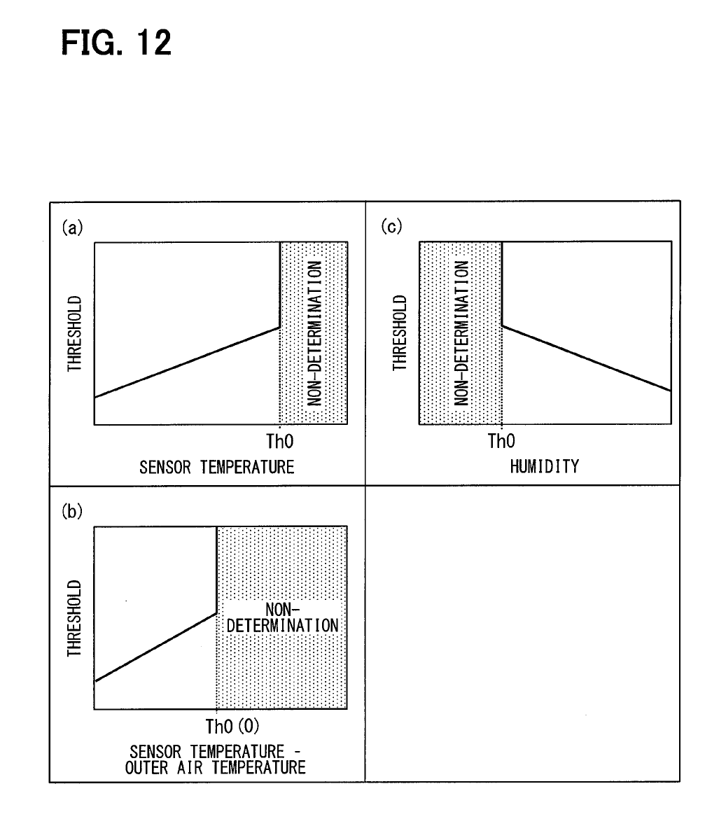

Further, as shown in (b) of FIG. 12 or (b) of FIG. 13, a temperature difference between the sensor temperature and the outer air temperature or a time change of the temperature difference can be used as the information relating to the sensor temperature for setting the threshold Th. In this case, the humidity processing unit 22 can acquire the temperature difference or the time change of the temperature difference. The humidity processing unit 22 may acquire the temperature difference by itself from the sensor signal indicating the intake temperature and the sensor signal indicating the outer air temperature, and may acquire the temperature difference from the control device 200. Further, the humidity processing unit 22 may acquire the time change of the temperature difference by itself from the temperature difference acquired as the above, and may acquire the time change of the temperature difference from the control device 200.

When a differential temperature obtained by subtracting the outer air temperature from the sensor temperature becomes lower, the humidity sensing unit 21b becomes more readily condensed. Further, when the time change of the differential temperature becomes larger at a negative side, the humidity sensing unit 21b becomes more readily condensed. The humidity processing unit 22 sets a threshold Th1 of when the temperature difference is large to be greater than a threshold Th2 of when the temperature difference is small. Similarly, when the time change of the temperature difference is used as the vehicle information, the humidity processing unit 22 sets a threshold Th1 of when the time change is large to be greater than a threshold Th2 of when the time change is small. Thus, the humidity processing unit 22 can improve the determination sensitivity of the condensation, that is, the humidity processing unit 22 can improve the determination sensitivity of the water adhesion.

In the humidity sensor device 20 of the present embodiment, the humidity processing unit 22 executes a processing of a flowchart shown in FIG. 11, while the ignition switch of the vehicle is being turned on or the vehicle is traveling.

At S20, the humidity processing unit 22 acquires the vehicle information. The humidity processing unit 22 acquires the vehicle information to determine whether to switch to a determination on whether water is adhered to the humidity sensing unit 21b. The vehicle information can use information relating to the humidity signal or the sensor temperature. S20 is equivalent to a determination information acquisition unit.

At S21, the humidity processing unit 22 determines whether to switch to the determination. The humidity processing unit 22 determines whether to switch to the determination on whether water is adhered to the humidity sensing unit 21b, by comparing the vehicle information acquired at S20 with a determination switching threshold Th0. When the humidity processing unit 22 determines to switch to the determination, the processing proceeds to S10, S11. When the humidity processing unit 22 determines not to switch to the determination, the processing returns to S20. S21 is equivalent to a switching determination unit.

The determination switching threshold Th0, for example, can use the sensor temperature as shown in (a) of FIG. 12. In this case, when the sensor temperature exceeds the determination switching threshold Th0, the humidity processing unit 22 determines a NO determination (negative determination) at S21 and does not execute the determination on whether water is adhered to the humidity sensing unit 21b. When the sensor temperature does not exceed the determination switching threshold Th0, the humidity processing unit 22 determines a YES determination (positive determination) at S21 and execute the determination on whether water is adhered to the humidity sensing unit 21b. As the above description, the humidity processing unit 22 executes the determination on whether water is adhered to the humidity sensing unit 21b only when the sensor temperature does not reach the determination switching threshold Th0.

The determination switching threshold Th0, for example, can use the time change of the sensor temperature as shown in (a) of FIG. 13. In this case, when the time change of the sensor temperature does not reach the determination switching threshold Th0, the humidity processing unit 22 determines a NO determination (negative determination) at S21 and does not execute the determination on whether water is adhered to the humidity sensing unit 21b. When the time change of the sensor temperature exceeds the determination switching threshold Th0, the humidity processing unit 22 determines a YES determination (positive determination) at S21 and executes the determination on whether water is adhered to the humidity sensing unit 21b. As the above description, the humidity processing unit 22 executes the determination on whether water is adhered to the humidity sensing unit 21b only when the time change of the sensor temperature exceeds the determination switching threshold Th0.

The determination switching threshold Th0, for example, can use the temperature difference between the sensor temperature and the outer air temperature as shown in (b) of FIG. 12. In this case, when the temperature difference exceeds the determination switching threshold Th0, the humidity processing unit 22 determines a NO determination (negative determination) at S21 and does not execute the determination on whether water is adhered to the humidity sensing unit 21b. When the temperature difference does not exceed the determination switching threshold Th0, the humidity processing unit 22 determines a YES determination (positive determination) at S21 and execute the determination on whether water is adhered to the humidity sensing unit 21b. As the above description, the humidity processing unit 22 executes the determination on whether water is adhered to the humidity sensing unit 21b only when the temperature difference does not reach the determination switching threshold Th0.

The determination switching threshold Th0, for example, can use the time change of the temperature difference between the sensor temperature and the outer air temperature as shown in (a) of FIG. 12. Similar to a case where the temperature difference is used, when the time change of the temperature difference exceeds the determination switching threshold Th0, the humidity processing unit 22 determines a NO determination (negative determination) at S21. When the time change of the temperature difference does not exceed the determination switching threshold Th0, the humidity processing unit 22 determines a YES determination (positive determination) at S21.

The determination switching threshold Th0, for example, can use a humidity (humidity signal) as shown in (b) of FIG. 12. In this case, when the humidity does not reach the determination switching threshold Th0, the humidity processing unit 22 determines a NO determination (negative determination) at S21 and does not execute the determination on whether water is adhered to the humidity sensing unit 21b. When the humidity exceeds the determination switching threshold Th0, the humidity processing unit 22 determines a YES determination (positive determination) at S21 and executes the determination on whether water is adhered to the humidity sensing unit 21b. As the above description, the humidity processing unit 22 executes the determination on whether water is adhered to the humidity sensing unit 21b only when the humidity reaches the determination switching threshold Th0.

According to the present embodiment, information relating to the sensor temperature is used as the vehicle information for setting the threshold Th. However, similar to the above embodiment, information indicating traveling information of the vehicle can be used.

1. A humidity measuring device located at a vehicle, the humidity measuring device including a humidity sensing unit configured to detect a humidity of an air, the humidity measuring device comprising:
a humidity information acquisition unit configured to acquire a variation quantity of the humidity with time or a humidity information that is information relating to the variation quantity of the humidity with time;
a vehicle information acquisition unit configured to acquire a vehicle information including at least one of information indicating a driving state of the vehicle or information of an attachment environment of the humidity sensing unit;
a threshold setting unit configured to set a threshold for determining whether water is adhered to the humidity sensing unit, based on the vehicle information; and
an adhesion determination unit configured to compare the humidity information with the threshold, the adhesion determination unit configured to determine that water is adhered to the humidity sensing unit when the humidity information reaches the threshold.

2. The humidity measuring device according to claim 1, wherein
the humidity sensing unit is located in an environment of an internal combustion engine of the vehicle where an intake air flows, and the humidity sensing unit is configured to measure the humidity of the intake air.

3. The humidity measuring device according to claim 1, wherein
the vehicle information acquisition unit is configured to acquire a vehicle speed of the vehicle or a time change of the vehicle speed, as the vehicle information, and
the threshold setting unit is configured to
(i) set the threshold of when the vehicle speed is high to be greater than the threshold of when the vehicle speed is low, in a case where the vehicle information acquisition unit acquires the vehicle speed as the vehicle information, and
(ii) set the threshold of when the time change of the vehicle speed is large to be greater than the threshold of when the time change of the vehicle speed is small, in a case where the vehicle information acquisition unit acquires the time change of the vehicle speed as the vehicle information.

4. The humidity measuring device according to claim 1, wherein
the vehicle information acquisition unit is configured to acquire an engine rotation speed of an internal combustion engine of the vehicle or a time change of the engine rotation speed, as the vehicle information, and
the threshold setting unit is configured to
(i) set the threshold of when the engine rotation speed is high to be greater than the threshold of when the engine rotation speed is low, in a case where the vehicle information acquisition unit acquires the engine rotation speed as the vehicle information, and
(ii) set the threshold of when the time change of the engine rotation speed is large to be greater than the threshold of when the time change of the engine rotation speed is small, in a case where the vehicle information acquisition unit acquires the time change of the engine rotation speed as the vehicle information.

5. The humidity measuring device according to claim 1, wherein
the vehicle information acquisition unit is configured to acquire an intake air flow rate of an internal combustion engine of the vehicle or a time change of the intake air flow rate, as the vehicle information, and
the threshold setting unit is configured to
(i) set the threshold of when the intake air flow rate is large to be greater than the threshold of when the intake air flow rate is small, in a case where the vehicle information acquisition unit acquires the intake air flow rate as the vehicle information, and
(ii) set the threshold of when the time change of the intake air flow rate is large to be greater than the threshold of when the time change of the intake air flow rate is small, in a case where the vehicle information acquisition unit acquires the time change of the intake air flow rate as the vehicle information.

6. The humidity measuring device according to claim 1, wherein
the vehicle information acquisition unit is configured to acquire a throttle opening degree of the vehicle or a time change of the throttle opening degree, as the vehicle information, and
the threshold setting unit is configured to
(i) set the threshold of when the throttle opening degree is large to be greater than the threshold of when the throttle opening degree is small, in a case where the vehicle information acquisition unit acquires the throttle opening degree as the vehicle information, and
(ii) set the threshold of when the time change of the throttle opening degree is large to be greater than the threshold of when the time change of the throttle opening degree is small, in a case where the vehicle information acquisition unit acquires the time change of the throttle opening degree as the vehicle information.

7. The humidity measuring device according to claim 1, wherein
the vehicle information acquisition unit is configured to acquire a time change of a temperature of the humidity sensing unit, as the information of the attachment environment of the humidity sensing unit which is the vehicle information, and
the threshold setting unit is configured to set the threshold of when the time change of the temperature is larger than a positive side to be less than the threshold of when the time change of the temperature is smaller than the positive side, in a case where the vehicle information acquisition unit acquires the time change of the temperature as the vehicle information.

8. The humidity measuring device according to claim 1, wherein
the vehicle information acquisition unit is configured to acquire a temperature difference between a temperature of the humidity sensing unit and an atmospheric temperature or a time change of the temperature difference, as the information of the attachment environment of the humidity sensing unit which is the vehicle information, and
the threshold setting unit is configured to
(i) set the threshold of when the temperature difference is small to be less than the threshold of when the temperature difference is large, in a case where the vehicle information acquisition unit acquires the temperature difference as the vehicle information, and
(ii) set the threshold of when the time change of the temperature difference is large to be less than the threshold of when the time change of the temperature difference is small, in a case where the vehicle information acquisition unit acquires the time change of the temperature difference as the vehicle information.

9. The humidity measuring device according to claim 1, further comprising:
a switching determination unit configured to determine whether to switch to a determination executed by the adhesion determination unit; and
a determination information acquisition unit configured to acquire the information of the attachment environment of the humidity sensing unit to execute the determination by the switching determination unit, wherein
the switching determination unit is configured to determine whether to switch to the determination executed by the adhesion determination unit, based on the information acquired by the determination information acquisition unit.

10. The humidity measuring device according to claim 9, wherein
the determination information acquisition unit is configured to acquire a temperature of the humidity sensing unit, as the information of the attachment environment of the humidity sensing unit, and
the switching determination unit is configured to
(i) determine to switch to the determination executed by the adhesion determination unit when the temperature acquired by the determination information acquisition unit does not exceed a predetermined value, and
(ii) determine not to switch to the determination executed by the adhesion determination unit when the temperature exceeds the predetermined value.

11. The humidity measuring device according to claim 9, wherein
the determination information acquisition unit is configured to acquire a temperature difference between a temperature of the humidity sensing unit and an atmospheric temperature, as the information of the attachment environment of the humidity sensing unit, and
the switching determination unit is configured to
(i) determine to switch to the determination executed by the adhesion determination unit when the temperature difference acquired by the determination information acquisition unit does not exceed a predetermined value, and
(ii) determine not to switch to the determination executed by the adhesion determination unit when the temperature exceeds the predetermined value.

12. The humidity measuring device according to claim 9, wherein
the determination information acquisition unit is configured to acquire a time change of a temperature difference between a temperature of the humidity sensing unit and an atmospheric temperature, as the information of the attachment environment of the humidity sensing unit, and
the switching determination unit is configured to
(i) determine to switch to the determination executed by the adhesion determination unit when the time change of the temperature difference acquired by the determination information acquisition unit does not exceed a predetermined value, and
(ii) determine not to switch to the determination executed by the adhesion determination unit when the time change of the temperature difference exceeds the predetermined value.

13. The humidity measuring device according to claim 1, wherein
the adhesion determination unit is configured to determine that water is adhered to the humidity sensing unit at a timing where the humidity information reaches the threshold.

14. The humidity measuring device according to claim 1, wherein
the humidity sensing unit is configured to detect a relative humidity as the humidity.

15. The humidity measuring device according to claim 1, wherein
the humidity sensing unit is configured to detect a weight absolute humidity as the humidity.

16. A humidity measuring device located at a vehicle, comprising:
a humidity sensor configured to detect a humidity of an air; and
at least one processor configured to perform:
acquiring a variation quantity of the humidity with time or a humidity information that is information relating to the variation quantity of the humidity with time,
acquiring a vehicle information including at least one of information indicating a driving state of the vehicle or information of an attachment environment of the humidity sensing unit,
setting a threshold for determining whether water is adhered to the humidity sensing unit, based on the vehicle information, and
comparing the humidity information with the threshold and determining that water is adhered to the humidity sensing unit when the humidity information reaches the threshold.

17. A humidity measuring device located at a vehicle, comprising:
a humidity sensing means for detecting a humidity of an air;
a humidity information acquisition means for acquiring a variation quantity of the humidity with time or a humidity information that is information relating to the variation quantity of the humidity with time;
a vehicle information acquisition means for acquiring a vehicle information including at least one of information indicating a driving state of the vehicle or information of an attachment environment of the humidity sensing unit;
a threshold setting means for setting a threshold for determining whether water is adhered to the humidity sensing unit, based on the vehicle information; and
an adhesion determination means for comparing the humidity information with the threshold, the adhesion determination means for determining that water is adhered to the humidity sensing unit when the humidity information reaches the threshold.
